(19) United States
(12) Patent Application Publication
(10) Pub. No.: US 2016/0021234 A1
(43) Pub. Date: Jan. 21, 2016

(54) CALL ANSWERING METHOD INTEGRATING SOCIAL SOFTWARE APPLICATION AND TELEPHONE ANSWERING INTERFACE

(71) Applicants: Ko-Chung CHIU, Taipei City (TW); Yi-Ju CHEN, Taipei City (TW); Hsuan-Kai CHIU, Taipei City (TW)

(72) Inventors: Ko-Chung CHIU, Taipei City (TW); Yi-Ju CHEN, Taipei City (TW); Hsuan-Kai CHIU, Taipei City (TW)

(21) Appl. No.: 14/799,583

(22) Filed: Jul. 15, 2015

(30) Foreign Application Priority Data
Jul. 18, 2014 (TW) 103124723

(51) Int. Cl. H04M 1/725; H04M 3/42; H04W 4/12; H04L 12/58

(52) U.S. Cl. CPC H04M 1/72552; H04L 51/32; H04M 3/42068; H04W 4/12; H04M 1/72525

(57) ABSTRACT

A call answering method integrating a social software application and a telephone answering interface is provided. The telephone is built-in with a telephone answering interface, a native address book and at least one social software application, and is installed with an integrated answering program. When the telephone receives a call request signal that an external caller transmits, the integrated answering program determines whether identity information the call request signal provides represents a social contact, and a social answering button corresponding to the social software application is displayed to quickly switch to the social software communication interface for text (short messages), graphic or file communication.

### BACKGROUND OF THE INVENTION

a) Field of the Invention

The invention relates in general to a call answering method integrating a social software application and a telephone answering interface, and more particularly, to a call answering method that selects to answer a call using a social software application or to accept an external voice call on a telephone answering interface.

b) Description of the Prior Art

A phone, whether a conventional cell phone or a high-performance smart phone, generally has a telephone answering interface P1 for answering calls and a message sending interface P2 exclusively for entering messages. The telephone answering interface P1 at least includes a physical or virtual accept function button P11 and a decline function button P12 (as shown in FIG. 1). The message sending interface P2 provides functions such as a text entering field P21 and a contact option P22 (as shown in FIG. 2).

When an external caller sends a call request signal to a recipient, a telephone of the recipient (the owner of the telephone) automatically displays the answering interface P1 on a display screen of the telephone to prompt the recipient to select “accept” or “decline” according his/her own will. To accept the call, the recipient presses the accept function button P11 to enter a call-receiving (call-accept) state. Alternatively, to decline the call, the recipient presses the decline function button P12, such that the caller is transferred a voice mailbox provided by the telecommunication service provider.

With the increasing utilization rate of short messages as well as infrequent voice messages in the voice mailbox and the habit of rarely listening to the voice mailbox, current mobile phones often additionally provide a design that triggers the message sending interface P2 (as shown in FIG. 2) at the time when the decline function button P12 is pressed. As the recipient presses the decline function button P12, not only the call request signal is disconnected, but also the message sending interface P2 (as shown in FIG. 2) is simultaneously triggered for the recipient to in real-time enter his/her status in text to the caller for further communication.

However, with the rapid prevalence of smart phones and cross-platform free social software applications (e.g., Line, WhatsApp and WeChat), almost all smart phones or common computers e.g., desktop computers or tablet computers) of business persons and students are installed with these free social software applications. In addition to sharing free messages in real-time in all circumstances, these social software applications also serve as another type of communication tool. As these social software applications are cost-free, most users usually first inform or enquire an intended recipient whether the recipient uses any social software application, and then manually switch the telephone answering interface P1 to the social software application to search for the social software communication interface of the recipient for further message communication. In the above approach, on top of the cost for the enquiry call, the process of repeatedly switching and searching for a contact is also quite time-consuming.

Therefore, it is a task of the present invention to effectively integrate a telephone answering interface and a social software communication interface.

### SUMMARY OF THE INVENTION

It is a primary object of the present invention to provide a call answering method integrating a social software application and a telephone answering interface. The method of the present invention is performed on a telephone including a processor and a memory. The telephone is built-in with a telephone answering interface capable of displaying accept and decline buttons, a native address book storing multiple contacts and at least one social software application. The telephone of the present invention is installed with an integrated answering program. The integrated answering program loads multiple social contacts in each social software application, establishes social address books respectively corresponding to different social software applications, or provides a social selecting interface for a user to select one or multiple contacts to be loaded to corresponding social address books. Alternatively, the user may establish (enter) information of one or multiple social contacts in corresponding social address books. When the telephone receives a call request signal transmitted from an external caller, the telephone performs the following steps.

In step a, the integrated answering program determines whether identity information (e.g., a telephone number or an address book name) the call request signal provides represents a social contact. The method ends when the determination result is negative.

In step b, when the determination result of step a is affirmative, the social software application to which the social contact belongs is determined.

In step c, a social answering button corresponding to the social software application is displayed at an appropriate position on the telephone answering interface, and it is for waited whether the social answering button generates a social answering signal. When the social answering button does not generate the social answering signal, the method ends.

In step d, when the social answering button generates the social answering signal, the integrated answering program triggers the social software application corresponding to the social answering button, so as to activate a social software communication interface of the social contact for text, graphic or voice file communication. Thus, on the telephone answering interface, the recipient is allowed to select to accept the voice call or to directly switch to the social software communication interface for text (short messages) or file communication.

According to the foregoing main characteristics, the integrated answering program establishes social address books respectively corresponding to different types of social software applications. For example, a first social software application establishes a first social address book, and a second social software application establishes a second social address book.

According to the foregoing main characteristics, the social software application in step c is a social software application such as Line, WhatsApp, WeChat or Skype.

According to the foregoing main characteristics, when any social answering button generates the social answering signal, the integrated answering program disconnects the call request signal or transmits a voice file to prompt the caller to communicate through the social software application.

According to the foregoing main characteristics, the identity information in step a is a telephone number, an identification code or an address book name.

It is another object of the present invention to provide a method for displaying a telephone answering interface including social software hotkeys. The method of the present invention is performed on a telephone including a processor and a memory. The telephone is built-in with a telephone answering interface capable of displaying accept and decline buttons, a native address book storing multiple contacts, and at least one social software application. The telephone of the present invention is installed with an integrated answering program. The integrated answering program loads multiple social contacts in each social software application to establish social address books respectively corresponding to different social software applications, or provides a social selecting interface for a user to select one or multiple contacts to be loaded to corresponding social address books. Alternatively, the user may establish (enter) information of one or multiple social contacts in the corresponding social address book. When the telephone receives a call request signal and displays the telephone answering interface, the integrated answering program performs the following steps.

In step a, it is determined whether identity information (e.g., a telephone number) the call request signal provides represents a social contact. The method ends when the determination result is negative.

In step b, when the determination result of step a is affirmative, the social software application to which the social contact belongs is determined.

In step c, a social answering button exclusive to the social software application corresponding to the social address book is displayed at an appropriate position on the telephone answering interface, and it is waited for whether the social answering button generates a social answering signal. When the social answering button does not generate the social answering signal, the method ends.

In step d, when the social answering button generates the social answering signal, the integrated answering program triggers the social software application corresponding to the social answering button, and activates a social software communication interface of the social contact for text, graphic or voice file communication. Thus, on the telephone answering interface, the recipient is allowed to select to accept the voice call or to directly switch to the social software communication interface for text (short messages) or file communication.

According to the foregoing main characteristics, the integrated answering program establishes social address books respectively corresponding to different types of social software applications. For example, a first social software application establishes a first social address book, and a second social software application establishes a second social address book.

According to the foregoing main characteristics, the social software application in step c is a social software application such as Line, WhatsApp, WeChat or Skype.

According to the foregoing main characteristics, when any social answering button generates the social answering signal, the integrated answering program disconnects the call request signal and transmits a voice file to prompt the caller to communication through the social software application.

According to the foregoing main characteristics, the identity information in step a is a telephone number or an identification code.

It is another object of the present invention to provide a social software application capable of displaying social software hotkeys on a telephone answering interface. The method of the present invention is performed on a telephone including a processor and a memory. The telephone is built-in with a telephone answering interface capable of displaying accept and decline buttons. The social software application includes a social address book. When the telephone receives a call request signal and displays the telephone answering interface, the social software application performs the following steps.

In step a, it is determined whether identity information (e.g., a telephone number) the call request signal provides represents a social contact. The method ends when the determination result is negative.

In step b, when the determination result of step a is affirmative, it is waited for whether the social answering button generates a social answering signal. When the social answering button does not generate the social answering signal, the method ends.

In step c, when the social answering button generates the social answering signal, the social software application activates a social software communication interface of the social contact for text, graphic or voice file communication.

As such, on the telephone answering interface, the recipient is allowed to select to accept the voice call or to directly switch to the social software communication interface for text (short messages) or file communication.

According to the foregoing main characteristics, the social software application a social software application such as Line, WhatsApp, WeChat or Skype.

According to the foregoing main characteristics, when the social answering button generates the social answering signal, the integrated answering program disconnects the call request signal or transmits a voice file to prompt the caller to communicate through the social software application.

According to the foregoing main characteristics, the identity information in step a is a telephone number or an identification code.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic diagram of an answering interface of a common telephone of prior art;

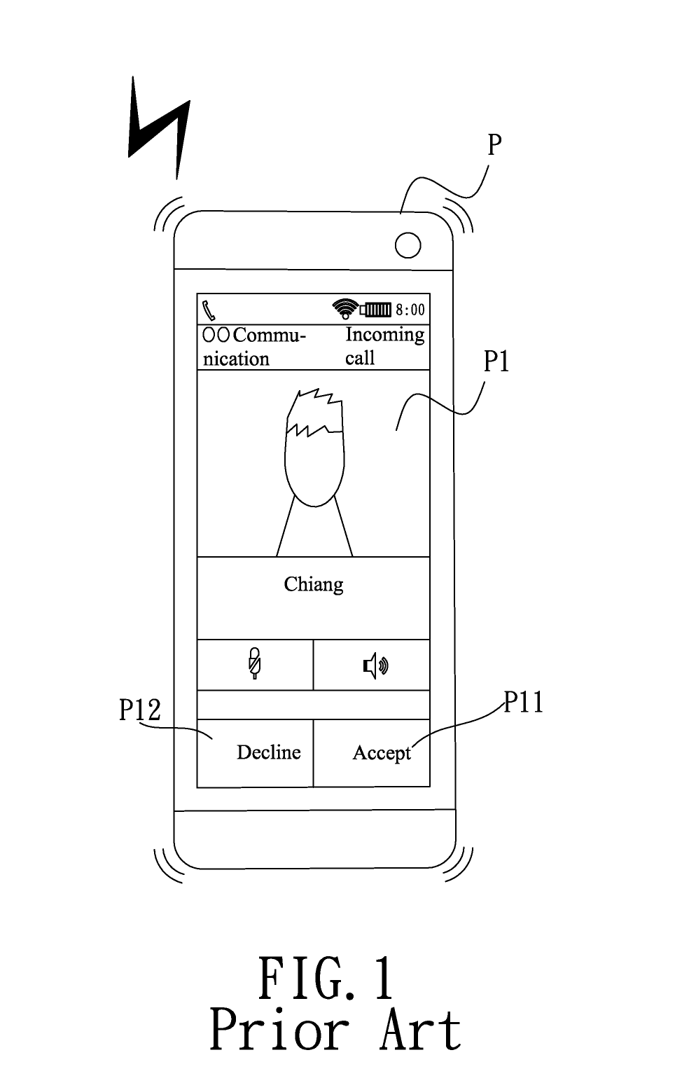

FIG. 2 is a schematic diagram of a text sending interface of a common telephone of prior art;

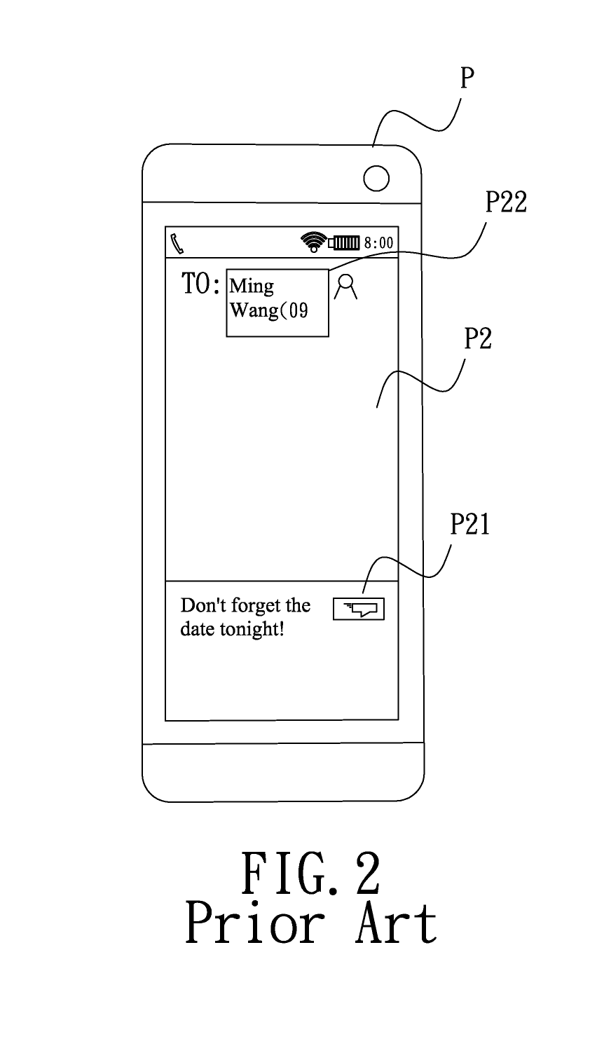

FIG. 3 is a schematic diagram of architecture of a call answering method integrating a social software application and a telephone answering interface of the present invention;

FIG. 4 is a flowchart of a call answering method integrating a social software application and a telephone answering interface of the present invention;

FIG. 5 is a schematic diagram of a telephone answering interface displayed by a call answering method integrating a social software application and a telephone answering interface of the present invention;

FIG. 6 is a schematic diagram of social answering buttons of a telephone answering interface displayed by a call answering method integrating a social software application and a telephone answering interface of the present invention;

FIG. 7 is a schematic diagram of a homepage of a social selecting interface of a call answering method integrating a social software application and a telephone answering interface of the present invention;

FIG. 8 is a schematic diagram of a social selecting interface of a call answering method integrating a social software application and a telephone answering interface of the present invention;

FIG. 9 is a schematic diagram of another social selecting interface of a call answering method integrating a social software application and a telephone answering interface of the present invention;

FIG. 10 is a schematic diagram of architecture of a method for displaying a telephone answering interface including social software hotkeys of the present invention;

FIG. 11 is a flowchart of a call answering method of a method for displaying a telephone answering interface including social software hotkeys of the present invention;

FIG. 12 is a schematic diagram of architecture of a social software application capable of displaying social software hotkeys on a telephone answering interface of the present invention; and

FIG. 13 is a flowchart of a call answering method of a social software application capable of displaying social software hotkeys on a telephone answering interface.

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings.

A method of the present invention may be performed on an application program a user independently installs, directly performed on a telephone answering interface of a cell phone, or directly performed on a social software application. The three above approaches are explained in detailed to illustrate characteristics of the present invention below. It should be noted that, the method of the present invention is not limited to the three examples above.

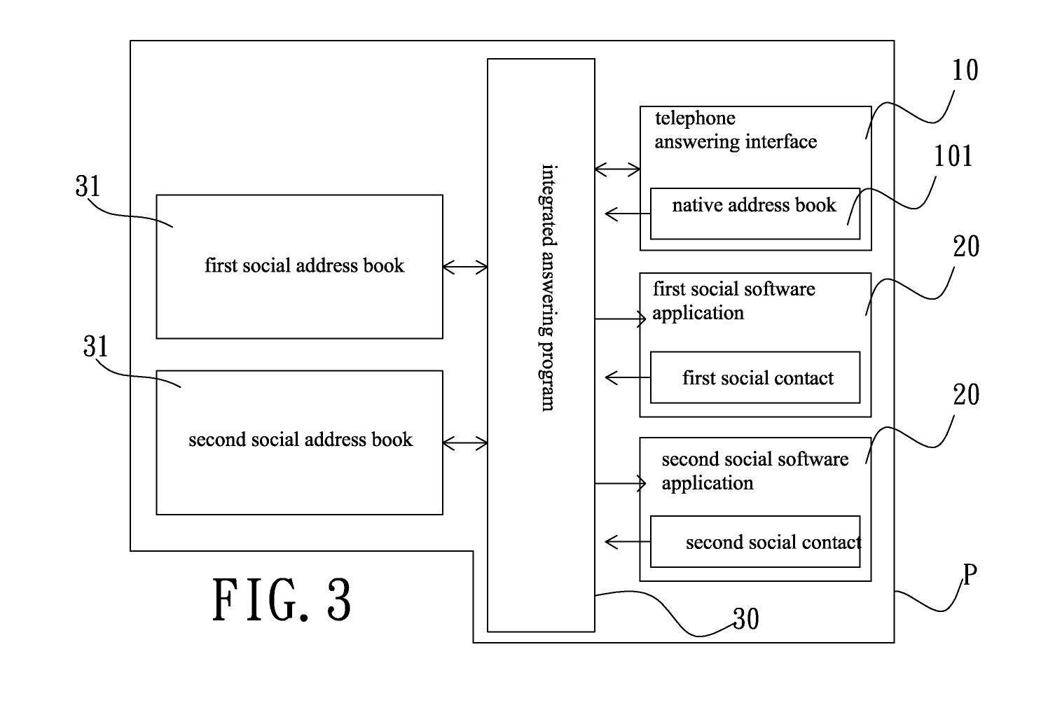

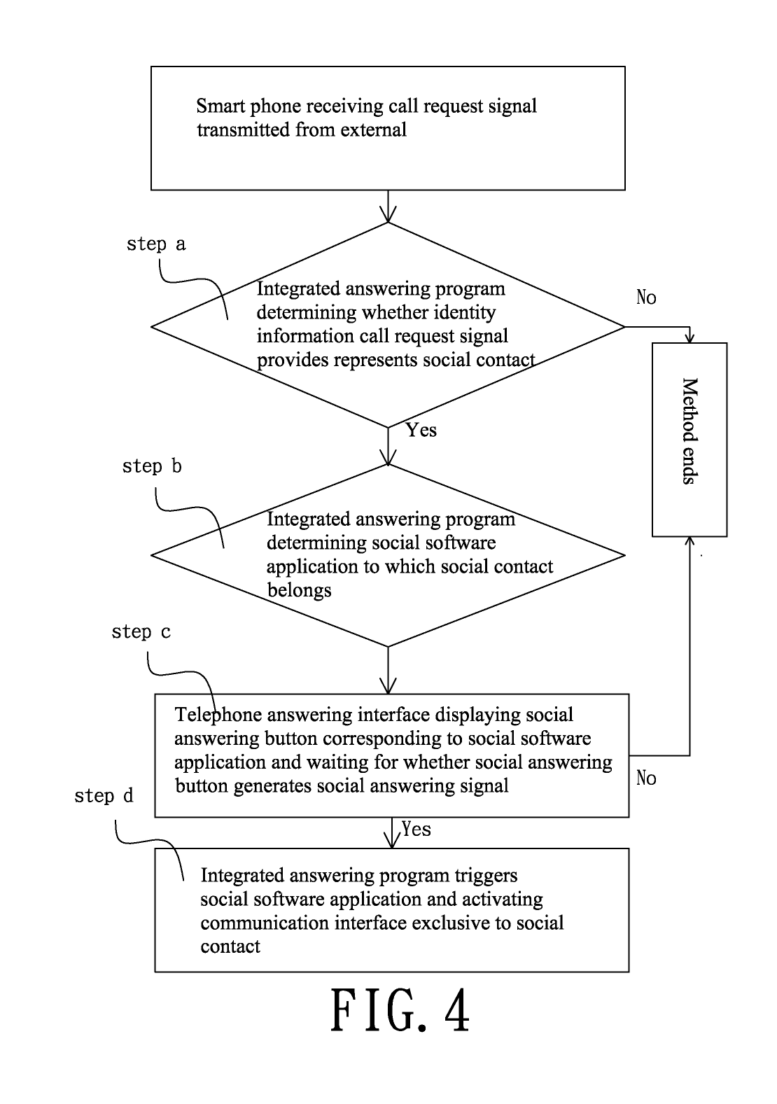

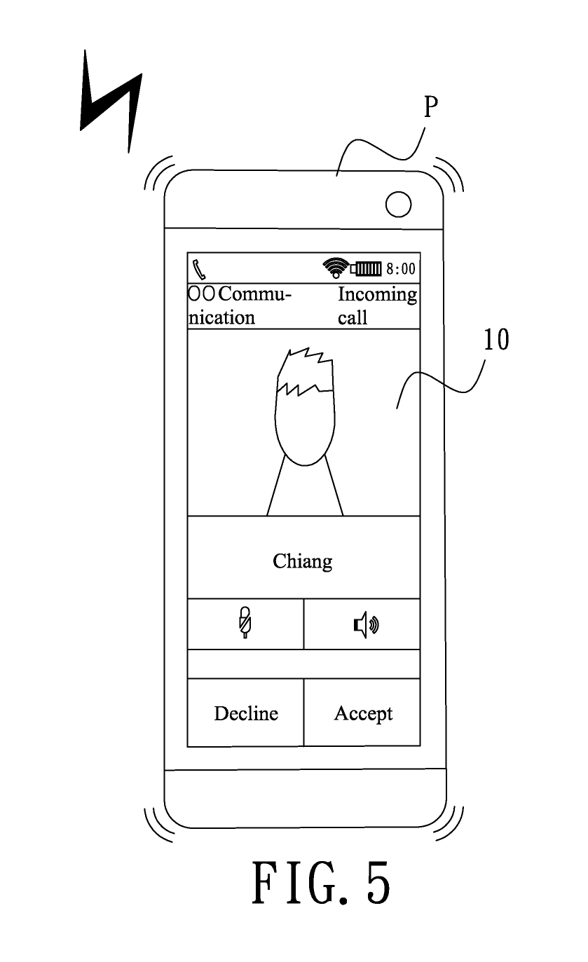

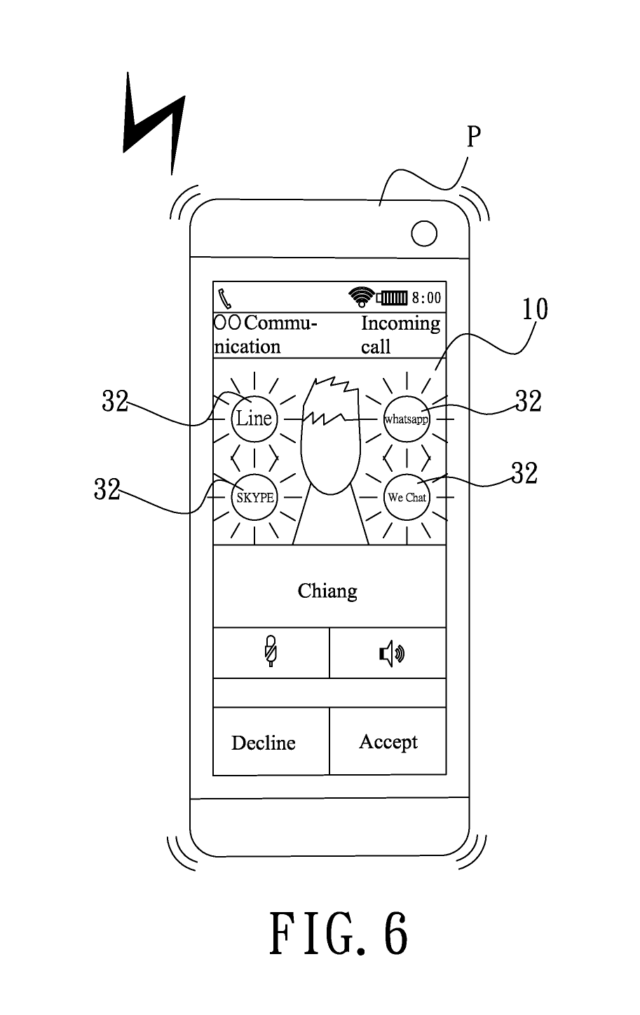

Refer to FIG. 3 to FIG. 6. FIG. 3 is a schematic diagram of architecture of a call answering method integrating a social software application and a telephone answering interface of the present invention. FIG. 4 is a flowchart of a call answering method integrating a social software application and a telephone answering interface of the present invention. FIG. 5 is a schematic diagram of a telephone answering interface displayed by a call answering method integrating a social software application and a telephone answering interface of the present invention. FIG. 6 is a schematic diagram of social answering buttons of a telephone answering interface displayed by a call answering method integrating a social software application and a telephone answering interface of the present invention.

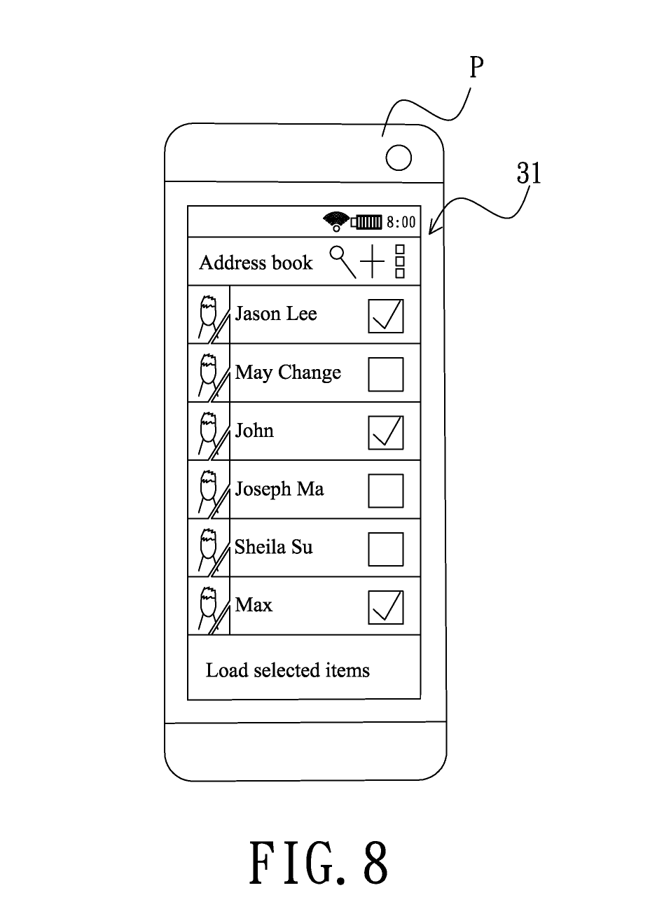

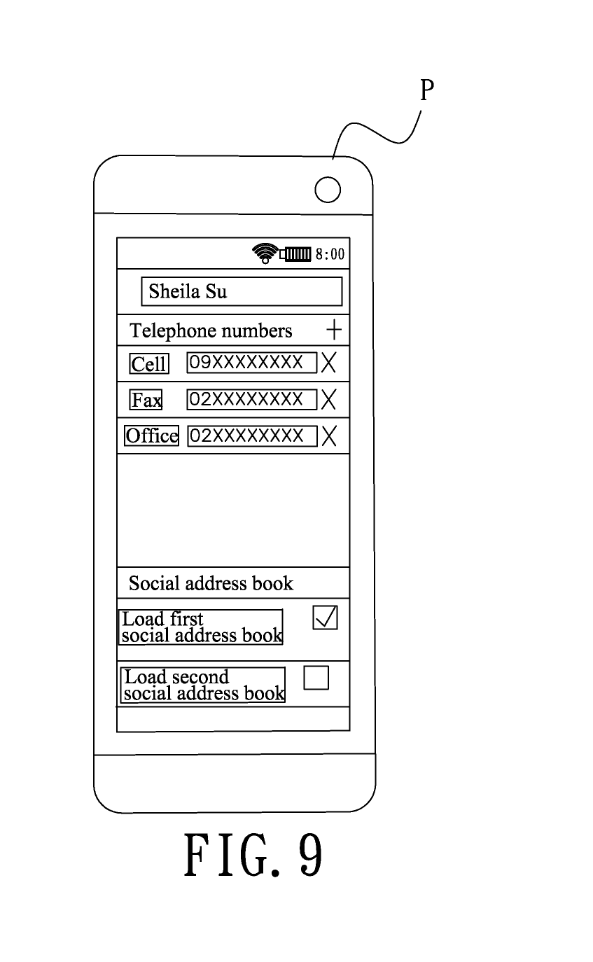

According to a first embodiment of the present invention, a call answering method integrating a social software application and a telephone answering interface is provided. The method according to the first embodiment of the present invention is performed on a telephone P including a central processing unit (CPU) and a memory. The telephone P is built-in with a telephone answering interface 10 capable of displaying accept and decline buttons, a native address book 101 storing multiple contacts, and at least one social software application 20. The telephone P of the present invention is installed with an integrated answering program 30. The integrated answering program 30 loads data of multiple social contacts stored in each social software application 20, and establishes social address books 31 (as shown in FIG. 3) respectively corresponding to different social software applications 20 in the integrated answering program 30. The integrated answering program 30 may establish a new social address book through many approaches. For example, a social selecting interface (as shown in FIG. 8 or FIG. 9) is provided, and one or multiple contacts to be loaded into the social address book 31 (e.g., the first or second social address book) are selected by the user from the native address book 101. Alternatively, the user may directly establish (enter) one or multiple social contacts (as shown in FIG. 9) on the social address book 31 (e.g., the first or second social address book).

When the telephone receives a call request signal transmitted from an external caller (as shown in FIG. 5), the following steps are performed (as shown in FIG. 3 and FIG. 4).

In step a, the integrated answering program 30 determines whether identity information that the call request signal provides (e.g., a telephone number or a unique identification code) represents a built-in contact. The method ends when the determination result is negative.

In step b, when the determination result of step a is affirmative, the integrated answering program 30 determines the social software application 20 to which the social contact belongs.

In step c, the integrated answering program 30 displays a social answering button 32 corresponding to the social software application 20 at an appropriate position on the telephone answering interface 10 (e.g., as shown in FIG. 6), and waits for whether the social answering button 32 generates a social answering signal. The method ends when the social answering button 32 does not generate the social answering signal.

In step d, when the social answering button 32 generates the social answering signal, the integrated answering program 30 disconnects the call request signal or transmits a voice file to prompt the caller to communicate through the social software application 20. Meanwhile, the integrated answering program 30 triggers the corresponding social software application 20 and activates a social software communication interface of the social contact for text, graphic or voice file communication. Thus, on the telephone answering interface 10, the recipient is allowed to select to accept the voice call or directly switch to the social software communication interface for text (short messages) or file communication.

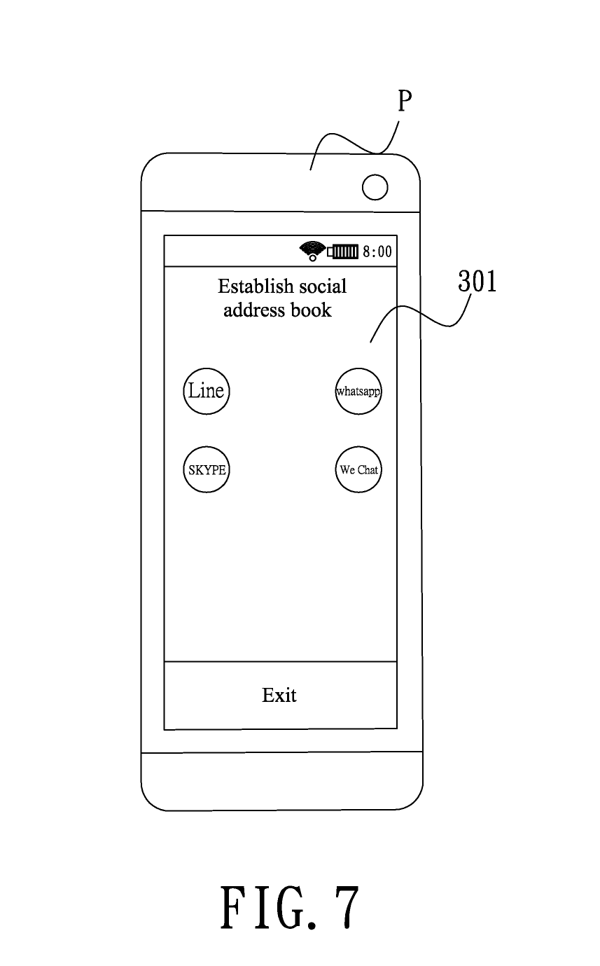

Again refer to FIG. 3 as well as FIG. 7 to FIG. 9. FIG. 7 is a schematic diagram of a homepage of a social selecting interface of a call answering method integrating a social software application and a telephone answering interface of the present invention. FIG. 8 is a schematic diagram of a social selecting interface of a call answering method integrating a social software application and a telephone answering interface of the present invention. FIG. 9 is a schematic diagram of another social selecting interface of a call answering method integrating a social software application and a telephone answering interface of the present invention.

As shown in FIG. 3 as well as FIG. 7 and FIG. 8, the integrated answering program 30 of the present invention may establish the social address books 31 respectively corresponding to different social software applications 20 through automatic or manual means. When the integrated answering program 30 of the present invention establishes the social contacts through manual means, the social selecting interface 301 needs to be first activated (as shown in FIG. 7). From the social selecting interface 301, the user selects the type of social software application (e.g., Line, WeChat, WhatsApp or Skype) to which the social contact is to be added. The integrated answering program 30 loads all contacts in the native address book 101 for the user to select from (as shown in FIG. 8), and one-time loads data of all of the selected contacts into the social address book 31 corresponding to the social software application 20 previously selected.

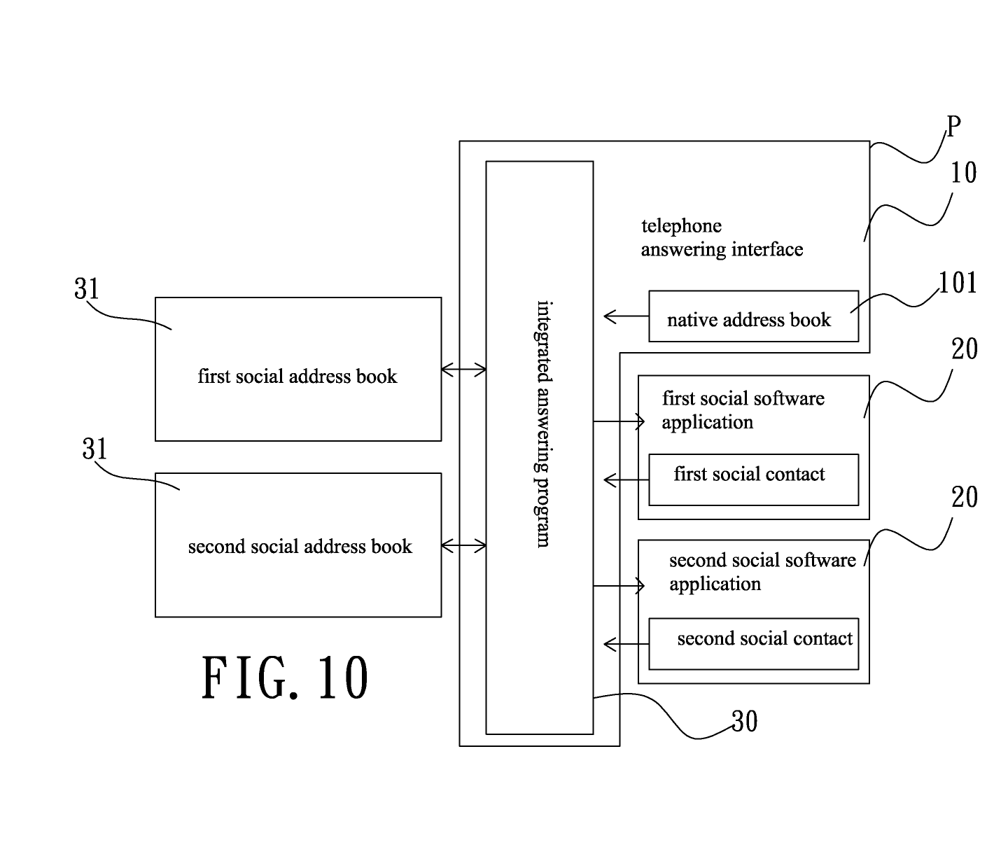

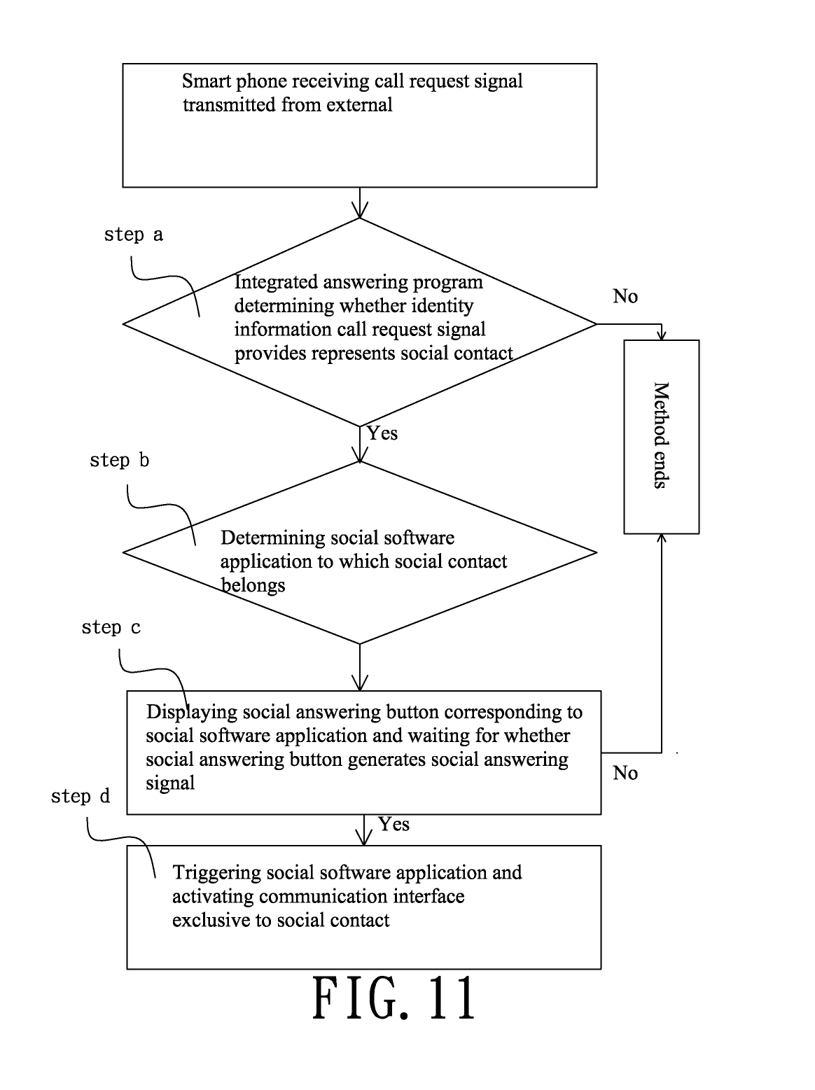

Refer to FIG. 10 and FIG. 11. FIG. 10 is a schematic diagram of architecture of a method for displaying a telephone answering interface including social software hotkeys of the present invention. FIG. 11 is a flowchart of a call answering method of a method for displaying a telephone answering interface including social software hotkeys of the present invention.

As shown in FIG. 10 and FIG. 11, according to a second embodiment of the present invention, a method for displaying a telephone answering interface including social software hotkeys is provided. The method of the present invention is performed on a telephone P including a central processing unit (CPU) and a memory. The telephone P is built-in with at least one telephone answering interface 10 capable of displaying accept and decline buttons, a native address book 101 storing multiple contacts, and at least one social software application 20. The method of the present invention is simultaneously triggered when the telephone answering interface 10 is displayed. When the method of the second embodiment is implemented, the user needs to first select one or multiple contacts to be loaded into the social address books 31 from the native address book 101 (as the description associated with FIG. 7 and FIG. 8), or the user defines the contact as a predetermined or simultaneously multiple social contacts while establishing (entering) one or multiple contacts. When the telephone P receives a call request signal and displays the telephone answering interface 10, the central processing unit (CPU) of the telephone P performs all of the steps below.

In step a, it is determined whether identity information (e.g., a telephone number) the call request signal provides represents a social contact. The method ends when the determination result is negative.

In step b, the social address book 31 to which the social contact belongs is determined.

In step c, the telephone answering interface 10 displays the social answering button 32 exclusive to the social software application 20 to which the social address book 31 belongs at an appropriate position on the telephone answering interface 10 (as shown in FIG. 6), and waits for whether the social answering button 32 generates a social answering signal. When the social answering button 32 does not generate the social answering signal, the method ends.

In step d, when the social answering button 32 generates the call answering signal, the method disconnects the call request signal or transmits a voice file to prompt the caller to communicate through the social software application 20. Meanwhile, the corresponding social software application 20 is triggered, and a social software communication interface of the social software application of the social contact is activated to accordingly perform text, graphic or voice file communication.

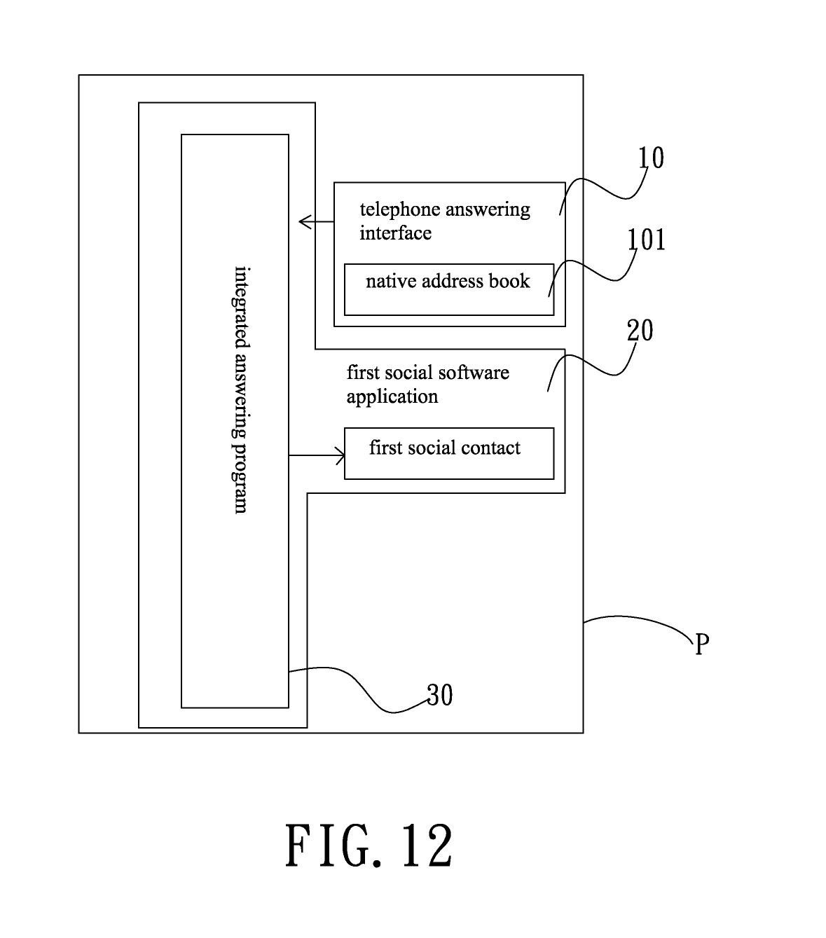

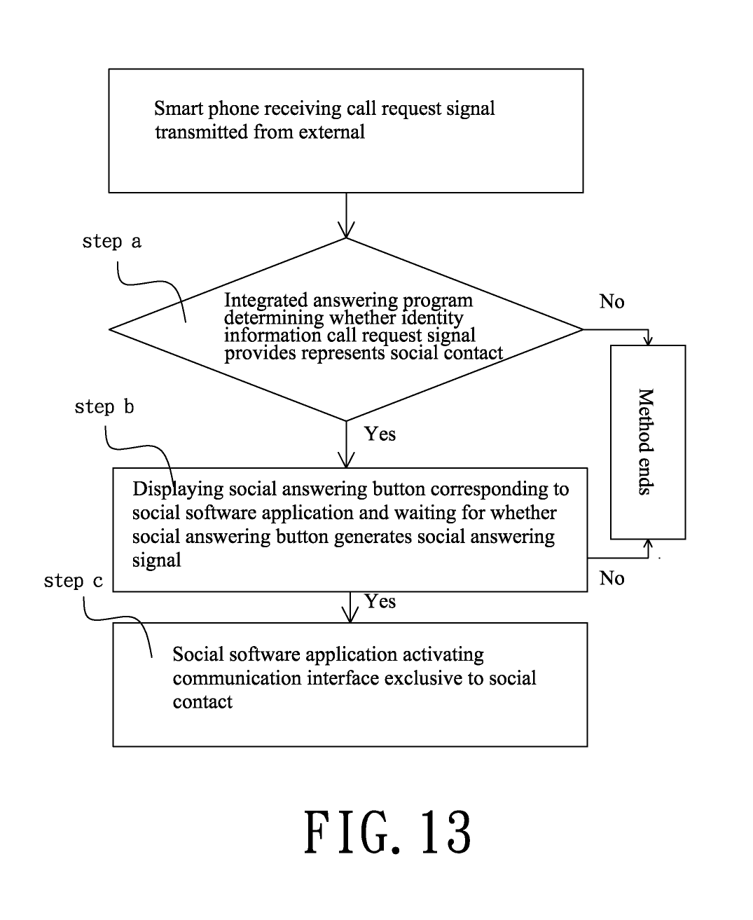

Again refer to FIG. 6 as well as FIG. 12 to FIG. 13. FIG. 12 a schematic diagram of architecture of a social software application capable of displaying social software hotkeys on a telephone answering interface. FIG. 13 is a flowchart a call answering method of a social software application capable of displaying hotkeys on a telephone answering interface.

According to a third embodiment of the present invention, a social software application capable of displaying social software hotkeys on a telephone answering interface is provided. The social software application according to the third embodiment is executed on a telephone P including a processor and a memory. The telephone P is built-in with at least one telephone answering interface 10 capable of displaying accept and decline buttons, and is installed with a social software application 20. The social software application 20 includes a social address book. When the telephone receives a call request signal and displays the telephone answering interface, the social software application performs the following steps.

In step a, it is determined whether identity information (e.g., a telephone number) the call request signal provides represents a social contact. The method ends when the determination result is negative.

In step b, when the determination result of step a is affirmative, a social answering button 32 (as shown in FIG. 6) exclusive to the social software application 20 is displayed at an appropriate position on the telephone answering interface 10, and it is waited for whether the social answering button 32 generates a social answering signal. The method ends when the social answering button 32 does not generate the social answering signal.

In step c, the social software application 20 activates a social software communication interface to which the social contact belongs for text, graphic or voice file communication. As such, on the telephone answering interface 10, the recipient is allowed to select to accept a voice call or to directly switch to the social software communication interface for text (short messages) or file communication.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A call answering method integrating a social software application and a telephone answering interface, performed on a telephone comprising a central processing unit (CPU) and a memory; the telephone being built-in with the telephone answering interface, a native address book storing multiple contacts and at least one social software application; the telephone being installed with an integrated answering program; the integrated answering program being loaded with data of multiple social contacts stored in each social software application, and establishing social address books respectively corresponding to different social software applications; alternatively, the integrated answering program providing a social selecting interface, through which one or multiple contacts to be loaded into the native address book are selected; when the telephone receives an external call request signal, the call answering method comprising steps of:
step a: the integrated answering program determining whether identity information the call request signal provides represents a built-in contact; the method ending when a determination result is negative;
step b: when the determination result of step a is affirmative, determining a social software application to which the social contact belongs;
step c: displaying a social answering button corresponding to the social software application at an appropriate position on the telephone answering interface, and waiting for whether the social answering button generates a social answering signal; the method ending when the social answering button does not generate the social answering signal; and
step d: when the social answering button generates the social answering signal, the integrated answering program triggering the corresponding social software application, and activating a social software communication interface of the social contact for text, graphic or voice file communication.

2. The call answering method integrating a social software application and a telephone answering interface according to claim 1, wherein in step c, the social answering button generates the social answering signal, and the integrated answering program disconnects the call request signal or transmits a voice file.

3. A method for displaying a telephone answering interface comprising social software hotkeys, performed on a telephone comprising a central processing unit (CPU) and a memory; the telephone being built-in with the telephone answering interface, a native address book storing multiple contacts and at least one social software application; the telephone being installed with an integrated answering program; when the telephone receives a call request signal and displays the telephone answering interface, the central processing unit (CPU) of the telephone performing steps of:
step a: determining whether identity information the call request signal provides represents a built-in contact; the method ending when a determination result is negative;
step b: determining a social software application to which the social contact belongs;
step c: displaying a social answering button corresponding to the social software application at an appropriate position on the telephone answering interface, and waiting for whether the social answering button generates a social answering signal; the method ending when the social answering button does not generate the social answering signal; and
step d: triggering the corresponding social software application, and activating a social software communication interface of the social contact for text, graphic or voice file communication.

4. The method for displaying a telephone answering interface comprising social software hotkeys according to claim 3, wherein in step c, the social answering button generates the social answering signal, and the integrated answering program disconnects the call request signal or transmits a voice file.

5. A social software application capable of displaying social software hotkeys on a telephone answering interface, performed on a telephone comprising a processor and a memory; the telephone being built-in with a telephone answering interface; when the telephone receives a call request signal and displays the telephone answering interface, the social software application performing steps of:
step a: determining whether identity information the call request signal provides represents a social contact of the social software application; the method ending when a determination result is negative;
step b: when the determination result of step a is affirmative, displaying a social answering button corresponding to the social software application at an appropriate position on the telephone answering interface, and waiting for whether the social answering button generates a social answering signal; the method ending when the social answering button does not generate the social answering signal; and
step c: when the social answering button generates the social answering signal, the social software application activating a social software communication interface of the social contact for text, graphic or voice file communication.
